(19) United States
(12) Patent Application Publication
(10) Pub. No.: US 2010/0121690 A1
(43) Pub. Date: May 13, 2010

(54) SYSTEM AND METHOD FOR PROVIDING A PERSONALIZED MOBILE ADVERTISING SERVICE

(75) Inventors: Ji-Hye LEE, Suwon-si (KR); Hae-Young JUN, Anyang-si (KR); Seok-Hoon CHOI, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd,, Suwon-si (KR)

(21) Appl. No.: 12/618,397

(22) Filed: Nov. 13, 2009

(30) Foreign Application Priority Data
Nov. 13, 2008 (KR) 10-2008-00112977

(51) Int. Cl. G06Q 30/00

(52) U.S. Cl. 705/14.1; 705/14.55; 705/14.64

(57) ABSTRACT

A method and system are provided for providing a personalized mobile advertising service by a mobile terminal in a mobile advertising system. The method includes receiving a message requesting an advertisement list through an advertising application, providing the requested advertisement list to a user through the advertising application, receiving a request message for a predetermined advertisement among advertisements included in the provided advertisement list through the advertising application, and delivering the requested advertisement to the advertising application.

### PRIORITY

This application claims priority under 35 U.S.C. §119(a) of a Korean Patent Application filed in the Korean Intellectual Property Office on Nov. 13, 2008 and assigned Serial No. 10-2008-00112977, the entire disclosure of which is incorporated herein by reference.

### BACKGROUND OF THE INVENTION

1. Field of the Invention The present invention relates generally to a mobile advertising system offering a user a personalized mobile advertising service, and more particularly, to a system and method for providing a list of advertisements, which are pre-fetched by a mobile terminal, in a mobile advertising system.

2. Description of the Related Art

The mobile communication market continuously requires creation of new services, which are sometimes achieved through recombination or integration of existing technologies. Current development of communication and broadcast technologies has enabled conventional broadcasting systems and mobile communication systems to provide broadcast services through portable terminals (or mobile terminals), such as mobile phones and Personal Digital Assistants (PDAs).

Accordingly, convergence of mobile communication service and Internet Protocol (IP) has become a priority in the development of next generation mobile communication technologies.

Open Mobile Alliance (OMA), a group for studying a standard for interworking between individual mobile solutions, defines various application standards for mobile games, Internet services, etc. Of the OMA Working Groups, Open Mobile Alliance Requirement (OMA REQ) Working Group and Open Mobile Alliance Content Delivery (OMA CD) Working Group are currently researching a technology standard for offering Mobile Advertising (MobAd) services.

MobAd is a technology for delivering customized or personalized advertisements based on music, graphic, voice and text technologies to users through mobile terminals (e.g., mobile phones, PDAs, etc.). However, despite the large number of currently available solutions supporting MobAd, each company and service provider use their own unique software, causing a reduction in compatibility and spread of the MobAd service.

Features of MobAd can be roughly summarized in the following three points.

First, MobAd builds an information database for users and enables realization of personalized advertisements suited for a distinctive feature of each individual. Because a user carries a mobile terminal on their person, the service provider may deliver selected advertisements to the mobile terminal of the user at stated periods or upon request of the user, and advertisements over the mobile terminal can be quickly seen by the user.

Second, MobAd facilitates bidirectional interaction. Because MobAd can provide information about advertisements desired by a user in advance, along with associated phone numbers and Uniform Resource Locators (URLs), the user may actively access the advertisements and get more detailed information about advertised goods.

Third, MobAd can gauge metrics of users. Mobile terminals, which are interactive media, can attract reactions (or metrics) from users who are exposed to the advertisements. Such metrics may be effectively used to analyze preferences of users and map out a marketing strategy.

FIG. 1 illustrates a conventional configuration of a MobAd system and interface connections in a mobile communication system.

The MobAd system includes an advertising engine (Ad Engine) 140 and an advertising server (Ad Server) 120. The Ad Engine 140 is a function group including logical modules, and is located in a user mobile terminal and accesses the Ad Server 120. The Ad Server 120 is a MobAd Enabler component located in a network, and is used to provide advertisements to the Ad Engine 140 and a Service Provider application (SP App) 130. The SP App 130, which is an external entity, is used to request and receive advertisements from the Ad Server 120, display the received advertisements with contents to the user, and provide advertising metrics (Ad metrics) to the Ad Server 120. A Web portal, a Multimedia Messaging Service (MMS) Relay/Server, a Short Message

Service Center (SMSC), and a game server are each an example of the Ad App 130. A Contextualization and Personalization Resources (C&PR) 110 is a storage of user-related information, and may include user personal features and preferences, etc. The C&PR 110 is used to obtain user requirements during advertisement selection.

The Ad Engine 140 interacts with all advertising application (Ad App) 150, i.e., an application utilizing the MobAd system, and supports a function capable of accessing a MobAd service from the Ad App 150 through the Ad Engine 140. In addition, the Ad Engine 140 provides an Ad Handling Function, an Ad Metrics Handling Function, and a User/Service/Device Data Handling Function. The Ad Handling Function supports a function of receiving advertisements from the Ad Server 120, and selecting advertisements stored in a cache of the mobile terminal; or handling and applying criteria to be used to send an advertisement request to the Ad Server 120, receiving an advertisement request from the Ad App 150, and providing an advertisement corresponding to the advertisement request. The Ad Metrics Handling Function supports a function of receiving Ad metrics from the Ad App 150, combining the Ad metrics with information (e.g., the time for which the Ad metrics were measured) that the Ad Engine 140 has, checking and representing the fraudulence of the received Ad metrics, and providing the Ad metrics to the Ad Server 120. The User/Service/Device Data Handling Function supports a function of handling dynamic/static information about the user/device, and providing MobAd service-related data (e.g., rule, policy, etc.).

The Ad Server 120 is a function group including logical modules, and performs such functions as Ad Selection Function, Ad Delivery Function, Ad Metrics Handling Function, and User/Service/Device data handling function. The Ad Selection Function supports a function of handling data provided from other authorized principals for advertisement selection, comparing and filtering advertisements based on given criteria, and selecting advertisements based on given rules and criteria. The Ad Delivery Function provides Ad metadata associated with advertisements or Ad campaigns to the Ad Engine 140 and the SP App 130, and delivers rules and instructions containing a usage of advertisements. The Ad Metrics Handling Function supports collects impression and user response information of received advertisements from the Ad Engine 140 and the SP App 130, collects and handles Ad metrics-related information (e.g., information about the time for which the advertisements were exposed), and integrates a variety of received Ad metrics. The User/Service/Device Data Handling Function handles user context data and MobAd Enabler Service-related data, generates and selects groups, generates advertising channels, and handles advertisements and Ad metadata.

Table 1 below shows interfaces used between constituent elements (or logical entities) in FIG. 1.

TABLE 1

| Interface | Description |
|---|---|
| TBD-1 | Represents a collection of all interfaces between Ad Server and SP App, |
| | other than MobAd-2 |
| TBD-2 | Represents a collection of all interfaces between Ad Server and Ad Engine, |
| | other than MobAd-3 and Delv-1 |
| TBD-3 | Represents a collection of all other interfaces between Ad Engine and Ad |
| | App, other than MobAd-1 |
| MobAd-1 | MobAd-1 is an interface between the Ad Engine and the Ad App. The Ad |
| | Engine exposes this interface to the Ad App. The Ad App uses this |
| | interface to request and obtain Ads and their associated Ads identifiers |
| | from the Ad Engine, as well as to report Ad metrics data to the Ad Engine, |
| | accompanied by the associated Ads identifiers. |
| MobAd-2 | MobAd-2 is an interface exposed by the Ad Server and used by the SP App |
| | to submit an Ad Request message with some parameters, as well as to |
| | report metrics data. The Ad Server uses this interface to provide an Ad |
| | Response to the SP App, which includes Ads and their associated Ads |
| | identifiers. The associated Ads identifiers will be used for reporting metrics |
| | data. This interface can also be used by the Ad Server to inform the SP App |
| | that some ads (stored locally by the SP App) should be deleted. This can be |
| | achieved either by attaching Ad deletion information to an SP App Ad |
| | Response, or by supporting an Ad Validity request from SP App to Ad |
| | Server (e.g.: SP App Validity request may be attached to an SP App Ad |
| | Request or the SP App Ad Validity request frequency may be set by an SP |
| | policy). |
| MobAd-3 | MobAd-3 is an interface between the Ad Server and the Ad Engine. The Ad |
| | Server exposes this interface to the Ad Engine. The Ad Engine uses this |
| | interface to request and obtain Ads and their associated Ads identifiers |
| | from the Ad Server, as well as to report Ad metrics data to the Ad Server, |
| | accompanied by the associated Ads identifiers. |
| DELV-1 | Delv-1 is an optional interface exposed by the Ad Engine. The Ad Engine |
| | receives Ads and/or Ad Metadata over this interface from the Ad Server via |
| | underlying push and/or broadcast delivery mechanisms. The Ad Server uses |
| | this interface to push either Ads or notification that Ads are available for |
| | retrieval. The Ad Server may also use this interface to provide service |
| | notification to the Ad Engine (e.g. information that SP caching and pre- |
| | fetching policies have been dynamically updated; An Ad or campaign |
| | needs to be cancelled ASAP, rules have changed, etc). |

FIG. 2 illustrates a conventional process of receiving advertisements in a mobile terminal.

Referring to FIG. 2, the Ad Engine 140 in the mobile terminal sends an Ad Request message to the Ad Server 120 in step 201, receives the requested advertisement from the Ad Server 120 in step 202, and stores the received advertisement in a storage or a cache in step 203. The Ad Server 120 may deliver an advertisement upon request of the

Ad Engine 140, or may deliver an advertisement even in the absence of request from the Ad Engine 140. If there is a new advertisement or an existing advertisement is updated, the Ad Engine 140 may send a request for the advertisement and its associated Ad metadata to the Ad Server 120 in step 201. The Ad Server 120 may deliver, to the Ad Engine 140, a personalized advertisement that is generated based on contextualization information such as a location and a storage status of the mobile terminal, and personalization information such as sex, age, personal preferences and interests of the mobile terminal's user.

Upon receiving an Ad Request message from the Ad App 150 in step 204, after storing the advertisement delivered from the Ad Server 120 in the cache, the Ad Engine 140 selects an advertisement meeting the criteria among the advertisements received from the Ad Server 120 by filtering the stored Ad Apps in step 205, and delivers the selected advertisement to the Ad App 150 in step 208. If none of the advertisements stored in the Ad Engine 140 match the advertisement requested by the Ad App 150, the Ad Engine 140 may forward the Ad Request message received from the Ad App 150 to the Ad Server 120 in step 206, and receive a matching advertisement to the advertisement requested by the Ad App 150 from the Ad Server 120 in step 207.

As described above, the user sends an Ad Request message to the Ad Engine 140 through the Ad App 150 in order to request an advertisement. If there is an advertisement among pre-fetched advertisements, which is matched to the criteria satisfying personalization information received from the user and contextualization information, the Ad Engine 140 provides a personalized mobile advertising service by selecting the advertisement and delivering the selected advertisement. However, because the user may not previously know a list of the pre-fetched advertisements stored in the Ad Engine 140 of the mobile terminal or an incentive of an advertisement at issue, before the user receives the advertisement, the user has no alternative but to receive advertisements depending on the Ad Selection or Filtering function of the Ad Engine 140. Therefore, a need exists for a method of providing a personalized mobile advertising service that enables a user to select and view desired advertisements by enabling the user to previously know a list of pre-fetched advertisements stored in the Ad Engine 140 and incentives of the advertisements, if advertisements are pre-fetched and stored in the Ad Engine 140.

In addition, conventionally, because the Ad Engine 140 previously downloads advertisements from the Ad Server 120 and stores the downloaded advertisements in the cache, even though contracts are changed due to the frequent policy changes or the regulations owing to features of advertisements, the related advertisements cannot be corrected or deleted, and after the change of the advertisements, the user cannot help but continuously view the wrong advertisements until the lifetime of the advertisements expires. Therefore, there is a need for a method capable of correcting, deleting, or canceling stored advertisements upon request of an Ad Server, even after the advertisements are stored in a mobile terminal.

### SUMMARY OF THE INVENTION

The present invention is designed to address at least the above-mentioned problems and/or disadvantages and to provide at least the advantages described below. Accordingly, an aspect of the present invention provides a system and method for enabling a user to acquire a list of pre-fetched advertisements stored in an Ad Engine of a mobile terminal and incentives of related advertisements, before actually receiving the advertisements.

Another aspect of the present invention provides a system and method for correcting or deleting advertisements, among the pre-fetched advertisements stored in a mobile terminal.

In accordance with an aspect of the present invention, a method for providing a personalized mobile advertising service by a mobile terminal in a mobile advertising system is provided. The method includes receiving a message for requesting an advertisement list through an advertising application; filtering advertisements that have been received from an advertising server and stored, and providing the requested advertisement list to a user through the advertising application; and receiving a request message for a predetermined advertisement among advertisements included in the provided advertisement list through the advertising application, and delivering the requested advertisement to the advertising application.

In accordance with another aspect of the present invention, a mobile advertising system for providing a personalized mobile advertising service is provided. The system includes an advertising server for providing advertisements; and an advertising engine for receiving an advertisement request through an advertising application, filtering advertisements provided from the advertising server, and providing the requested advertisement to the advertising application. The advertising engine receives a message for requesting an advertisement list through the advertising application, filters advertisements that have been received from the advertising server and stored, and provides the requested advertisement list to a user through the advertising application.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a diagram illustrating a conventional configuration of a MobAd system and connections of interfaces in a mobile communication system;

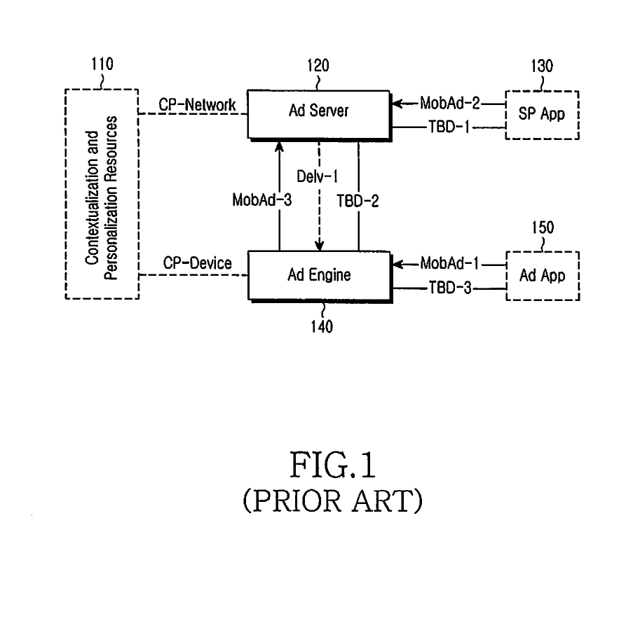

FIG. 2 is a diagram illustrating a conventional process of receiving advertisements in a mobile terminal;

FIG. 3 is a diagram illustrating a procedure for providing a list of pre-fetched advertisements and incentives of advertisements to a user by a mobile terminal according to an embodiment of the present invention; and

FIG. 4 is a diagram illustrating a process of updating pre-fetched advertisements according to an embodiment of the present invention.

Throughout the drawings, the same drawing reference numerals will be understood to refer to the same elements, features, and structures.

### DETAILED DESCRIPTION OF EMBODIMENTS OF THE INVENTION

The matters defined in the description, such as a detailed construction and elements, are provided to assist in a comprehensive understanding of certain embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the following description, representative embodiments of the present invention will be presented to achieve the technical tasks stated above. Although names of entities defined by 3^{rd} Generation Partnership Project (3GPP), which is a 3^{rd} generation mobile communication standard, or by MobAd of Open Mobile Alliance (OMA) will be used in the description, the standards and entity names are not intended to limit the scope of the present invention, as the present invention is applicable to any other systems having similar technical backgrounds.

In accordance with an embodiment of the present invention, a system and method for enabling a user to acquire in advance a list of pre-fetched advertisements stored in an Ad Engine of a mobile terminal and incentives of related advertisements before actually receiving the advertisements are provided.

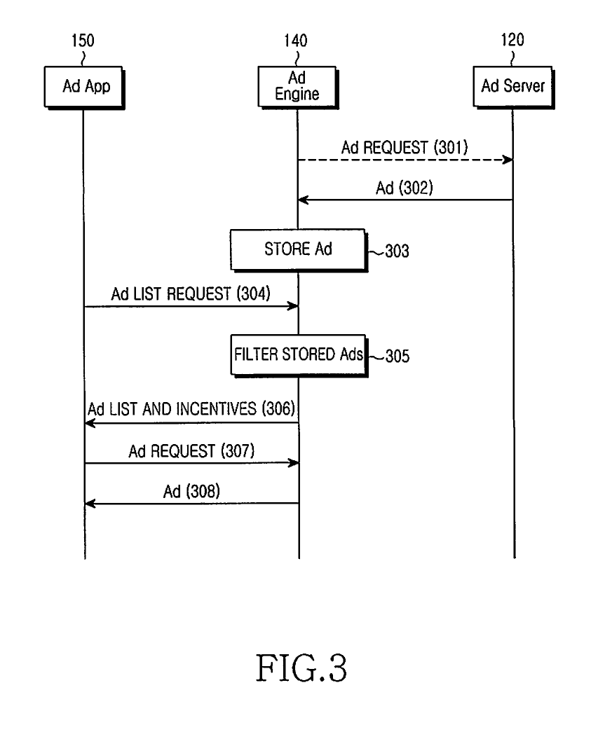

FIG. 3 illustrates a procedure for providing a list of pre-fetched advertisements and incentives of advertisements to a user through an Ad App 150 by an Ad Engine 140 in a mobile terminal according to an embodiment of the present invention.

Referring to FIG. 3, in step 301, the Ad Engine 140 sends an Ad request that is made by a user through the Ad App 150 (not shown), to the Ad Server 120 at stated periods or according to a preset schedule.

In step 302, the Ad Server 120 selects the requested advertisement and delivers the selected advertisement to the Ad Engine 140. The Ad Server 120 may deliver an advertisement upon request of the Ad Engine 140, or may deliver an advertisement even in the absence of a request of the Ad Engine 140.

In step 303, the Ad Engine 140 stores the advertisement received from the Ad Server 120. However, if the Ad request in step 301 was made by the user through the Ad App 150, the Ad Engine 140 may immediately deliver the advertisement received from the Ad Server 120 to the Ad App 150 without storing the received advertisement.

In step 304, the user sends a request for an Ad list to the Ad Engine 140 through the Ad App 150 using an Ad List Request message that includes a field used for requesting a list of pre-fetched advertisements. Regarding the Ad List Request message, a new separate message may be used, or a new file defined for requesting an Ad list may be included in the existing Ad Request message. For example, the Ad List Request message may be configured as shown below in Table 2 below.

TABLE 2

| Name | Description |
|---|---|
| Ad Request-ID | ID of the Ad Request Message, globally unique |
| Ad App-ID | ID of the Ad App, globally unique |
| Version | Version of the Ad Request. The newer version |
| | overrides the older one |
| User-ID | ID of the user who wants to request the ad |
| Name | Specify the name of user who wants to request |
| | the ad, possibly in multiple languages |
| List for pre-fetched ads | If this parameter is set, the Ad Engine will |
| and Incentives | provide the list of the pre-fetched ads and the |
| | brief description of each advertisement |
| | incentive, if available |
| Advertisement | The advertisement that will be requested |

In step 305, the Ad Engine 140 determines whether there are any advertisements pre-fetched from the Ad Server 120 by filtering the stored Ads, and sends an Ad List Response message to the Ad App 150 according to the determination results. That is, if there are pre-fetched advertisements, the Ad Engine 140 delivers a list of the pre-fetched advertisements and incentives of the advertisements to the Ad App 150 in step 306. If the Ad Engine 140 has pre-fetched advertisements but has no Ad list of the pre-fetched advertisements, the Ad Engine 140 sends an Ad List Response message with state information indicating the absence of the Ad list, to the Ad App 150. As to the Ad List Response message, a new separate message may be used, or the existing Ad Response message may be used. For example, the Ad List Response message may be configured as shown in Table 3 below.

TABLE 3

| Name | Description |
|---|---|
| Ad-Response-ID | ID of the Ad-Response Message, |
| | globally unique |
| Ad-Request-ID | ID of the Ad-Request, globally unique |
| Ad App-ID | ID of the Ad App, globally unique |
| List for pre-fetched ads | Specify the list of pre-fetched advertisements |
| and Incentives | and the brief description of each advertisement |
| | incentive |

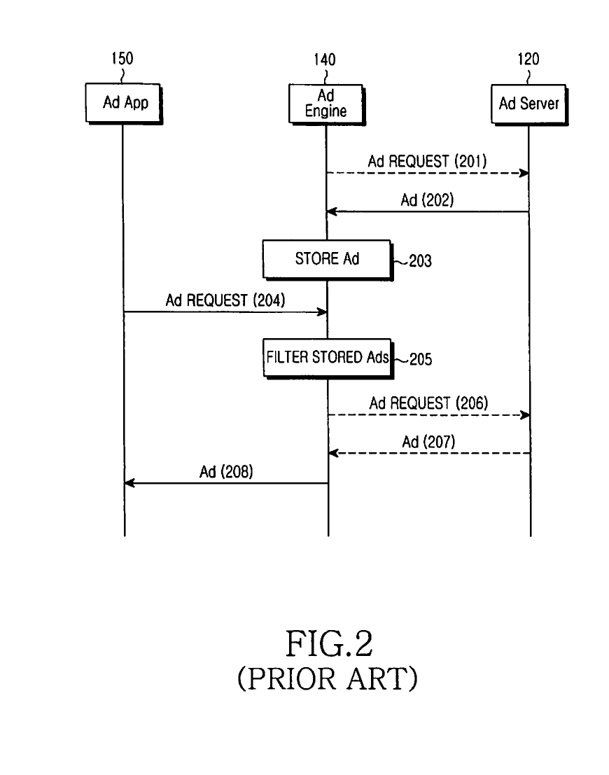

If it is not possible to provide an Ad list because of the absence of pre-fetched advertisements, the Ad Engine 140 may send an Ad request to the Ad Server 120, receive the requested advertisement, and deliver the received advertisement to the Ad App 150 as illustrated and described in steps 206 to 208 of FIG. 2.

In step 307, the user sends a request for a desired advertisement to the Ad Engine 140 based on the received Ad list and incentives. In step 308, the Ad Engine 140 provides the user-requested advertisement among the pre-fetched advertisements to the user through the Ad App 150).

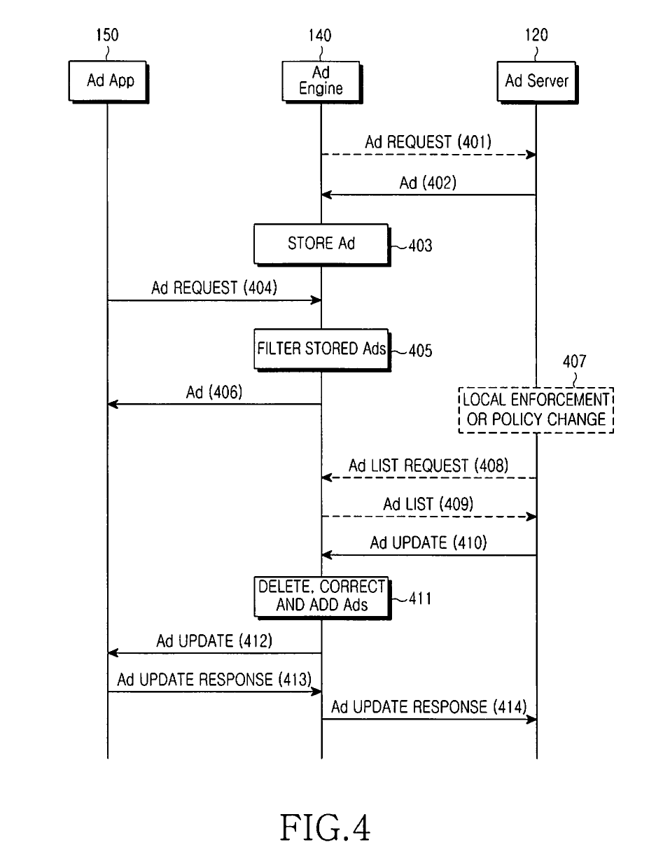

FIG. 4 illustrates a process of updating pre-fetched advertisements stored in a mobile terminal according to an embodiment of the present invention.

Referring to FIG. 4, the Ad Engine 140 sends an Ad Request message to the Ad Server 120 in step 401, receives the requested advertisement in step 402, and stores the received advertisement in step 403. Upon receiving an Ad request from the Ad App 150 in step 404, the Ad Engine 140 filters the stored advertisements in step 405, and delivers the requested advertisement to the Ad App 150 in step 406.

However, in step 407, if, for example, contracts of the pre-fetched advertisements have been cancelled or certain advertisements must be updated prior to an expiration set for the advertisements due to policy changes, the Ad Server 120 adds IDs of the advertisements to be updated to an Ad Update message and sends the Ad Update message to the Ad Engine 140 in step 410. The Ad Server 120 may use a variety of channels such as Peer-to-Peer (P2P), BCAST, and Multicast, when sending the Ad Update message.

Before sending the Ad Update message in step 410, the Ad Server 120 may send an Ad List Request message to the Ad Engine 140 in step 408 in order to acquire an Ad list stored in the mobile terminal. Then, in step 409, the Ad Engine 140 delivers an Ad list stored in the mobile terminal to the Ad Server 120.

Upon receiving the Ad Update message from the Ad Server 120, in step 411, the Ad Engine 140 corrects, adds, or deletes advertisements corresponding to IDs of the update-requested advertisements among the pre-stored advertisements based on the update request from the Ad Server 120, and in step 412, sends an Ad Update message indicating the update of the advertisements to the Ad App 150. Then the Ad App 150 stops displaying the advertisements in which the updated contents are reflected, or displays the corrected advertisements, and sends an Ad Update Response message to the Ad Engine 140 in step 413. The Ad Engine 140 forwards the Ad Update Response message received from the Ad App 150 to the Ad Server 120 in step 414.

As is apparent from the foregoing description, the above-described embodiments of the present invention provide a personalized mobile advertising service that enables, if there are pre-fetched advertisements in the Ad Engine, the user to acquire, in advance, a list of pre-fetched advertisements stored in the Ad Engine and incentives of the advertisements, and select and view desired advertisements.

In addition, considering that unlike the general communication information data or amusement data, advertisements are contents that are susceptible to policies or contracts, the above-described embodiments of the present invention immediately cope a change in an advertisement, due to a change in contracts as result of policy changes or regulations of the advertisements, using the Ad update procedure and method proposed by the present invention, thereby enabling a user to receive updated advertisements.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for providing a personalized mobile advertising service by a mobile terminal in a mobile advertising system, comprising:
receiving a message requesting an advertisement list through an advertising application;
providing the requested advertisement list to a user through the advertising application;
receiving a request message for a predetermined advertisement among advertisements included in the provided advertisement list through the advertising application; and
delivering the requested advertisement to the advertising application.

2. The method of claim 1, wherein providing the requested advertisement list comprises providing incentives of advertisements included in the advertisement list.

3. The method of claim 1, further comprising transmitting state information indicating an absence of the advertisement list to the advertising application, if there is no stored advertisement.

4. The method of claim 1, further comprising:
sending a request for an advertisement to an advertising server, if there is no stored advertisement;
receiving the requested advertisement from the advertising server; and
delivering an advertisement list for the received advertisement to the advertising application.

5. The method of claim 1, further comprising:
receiving update information including a change in a pre-fetched advertisement from an advertising server;
updating the pre-fetched advertisement according to the update information; and
providing the update result to a user through the advertising application.

6. The method of claim 5, further comprising:
receiving a message requesting a list of the pre-fetched advertisements from the advertising server, before receiving the update information; and
delivering the list of the pre-fetched advertisements to the advertising server.

7. The method of claim 5, wherein the updating the pre-fetched advertisement comprises deleting or correcting the pre-fetched advertisement corresponding to an advertisement Identifier (ID) included in the update information.

8. A mobile advertising system for providing a personalized mobile advertising service, comprising:
an advertising server for providing advertisements; and
an advertising engine for receiving an advertisement request through an advertising application, and providing a requested advertisement to the advertising application,
wherein the advertising engine receives a message requesting an advertisement list through the advertising application, and provides the requested advertisement list to a user through the advertising application.

9. The mobile advertising system of claim 8, wherein the requested advertisement list includes incentives of advertisements included therein.

10. The mobile advertising system of claim 8, wherein if there is no stored advertisement, the advertising engine transmits state information indicating an absence of the advertisement list to the advertising application.

11. The mobile advertising system of claim 8, wherein if there is no stored advertisement, the advertising engine sends a request for an advertisement to the advertising server, receives the requested advertisement from the advertising server, and then delivers an advertisement list for the received advertisement to the advertising application.

12. The mobile advertising system of claim 8, wherein the advertising engine receives update information including a change in a pre-fetched advertisement from the advertising server, updates a pre-fetched advertisement according to the update information, and provides an update result to the user through the advertising application.

13. The mobile advertising system of claim 12, wherein the advertising engine receives a message requesting a list of the pre-fetched advertisements from the advertising server, before receiving the update information, and delivers the list of the pre-fetched advertisements to the advertising server.

14. The mobile advertising system of claim 12, wherein the advertising engine updates the pre-fetched advertisement by deleting or correcting the pre-fetched advertisement corresponding to an advertisement Identifier (ID) included in the update information.
